(19) United States
(12) Patent Application Publication
(10) Pub. No.: US 2015/0306521 A1
(43) Pub. Date: Oct. 29, 2015

(54) CENTRIFUGAL SEPARATOR FOR REMOVING BUBBLES OF INSERTED MATTER IN SYRINGE

(71) Applicant: Henkel Technologies (Korea) Limited, Choongnam (KR)

(72) Inventors: Kyu-Chnang Sim, Seoul (KR); Jun-Soo Kim, Seoul (KR); Se-Hyun Kim, Seoul (KR)

(73) Assignee: HENKEL TECHNOLOGIES (KOREA) LIMITED, Choongnam, (KR)

(21) Appl. No.: 14/380,337

(22) PCT Filed: Sep. 4, 2013
(86) PCT No.: PCT/KR2013/007994

§ 371 Date: Aug. 21, 2014

(30) Foreign Application Priority Data
Sep. 4, 2012 (KR) 10-2012-0097565

(51) Int. Cl. B01D 19/00

(52) U.S. Cl. CPC B01D 19/0052; B01D 19/0068

(57) ABSTRACT

Disclosed is a centrifugal separation device for removing air bubbles from materials filled into syringes, the device including: a centrifugal separator having a round body, a sealing cover sealably mounted on top of the body, a rotary shaft and a rotary body rotated by the operation of a motor, mounting members coupled to hinge shafts formed on the four faces of the rotary body, the syringes mounted on the mounting members through respective stands, a vacuum pipe and a vacuum releasing pipe connected on the underside of the body, and a vacuum sensor mounted at the inside of the vacuum pipe; a vacuum driving part adapted to absorb the air from the interior of the body through the vacuum pipe to reduce the internal pressure of the body to a given pressure; a sensing part adapted to input the pressure value detected from the vacuum sensor to a controller; a motor driving part adapted to drive the motor to rotate the rotary shaft; and the controller adapted to operate the centrifugal separator, to constantly maintain the internal pressure of the body to a set value, and to drive the motor at set RPM and for set driving time.

### TECHNICAL FIELD

The present invention relates to a centrifugal separation device for removing fine air bubbles from the materials filled into syringes, and more particularly, to a centrifugal separation device for removing fine air bubbles from the materials filled into syringes that is configured to operate a centrifugal separator at a given vacuum pressure when adhesives used for a semiconductor manufacturing process are made, thus completely removing the fine air bubbles existing in the adhesives filled into the syringes.

### BACKGROUND ART

In a semiconductor manufacturing process, air bubbles generated from a liquid adhesive during the manufacturing of the liquid adhesive cause defects, and specifically, in case of a flip chip package where an adhesive is applied between a chip and a substrate and the chip and substrate are then soldered, fine air bubbles may exist in the adhesive, so that the solder flows into the air bubbles to cause electrical errors on the chip interconnect structure.

So as to prevent the occurrence of the defects due to the fine air bubbles existing in the adhesive, a syringe into which the manufactured adhesive is filled is mounted on a stand of a centrifugal separator, and after that, the centrifugal separator is activated to remove the fine air bubbles existing in the adhesive through centrifugal separation.

Even in case where the centrifugal separator is adopted to remove the fine air bubbles existing in the adhesive, however, it is actually difficult to remove micro-fine air bubbles existing in the adhesive filled in the syringe, so that a large number of air bubbles are undesirably found when the adhesive is dispensed.

### DISCLOSURE

### Technical Problem

Accordingly, the present invention has been made in view of the above-mentioned problems occurring in the prior art, and it is an object of the present invention to provide a centrifugal separation device for removing fine air bubbles from the materials filled into syringes that is configured to operate a centrifugal separator at a given vacuum pressure when adhesives used for a semiconductor manufacturing process are made, thus completely removing the fine air bubbles existing in the adhesives filled into the syringes.

### Technical Solution

To accomplish the above object, according to the present invention, there is provided a centrifugal separation device for removing air bubbles from materials filled into syringes, the device including: a centrifugal separator having a round body, a sealing cover sealably mounted on top of the body, a rotary shaft and a rotary body rotated by the operation of a motor, mounting members coupled to hinge shafts formed on the four faces of the rotary body, the syringes mounted on the mounting members through respective stands, a vacuum pipe and a vacuum releasing pipe connected on the underside of the body, and a vacuum sensor mounted at the inside of the vacuum pipe; a vacuum driving part adapted to absorb the air from the interior of the body through the vacuum pipe to reduce the internal pressure of the body to a given pressure; a sensing part adapted to input the pressure value detected from the vacuum sensor to a controller; a motor driving part adapted to drive the motor to rotate the rotary shaft; and the controller adapted to operate the centrifugal separator, to constantly maintain the internal pressure of the body to a set value, and to drive the motor at set RPM and for set driving time.

According to the present invention, preferably, the internal pressure of the body is in the range from 50 torr to 60 torr while the centrifugal separator is being operated.

According to the present invention, preferably, the motor is driven in the range from 700 RPM to 1200 RPM while the centrifugal separator is being operated.

### Advantageous Effects

According to the present invention, the centrifugal separation device for removing air bubbles from the adhesives filled into the syringes is configured to operate the centrifugal separator at a given vacuum pressure, thus completely removing the fine air bubbles existing in the adhesives filled into the syringes and further preventing the electrical defects from occurring due to the generation of unexpected air bubbles, which is one of the dangerous elements in the semiconductor assembling work.

In addition, the centrifugal separation device according to the present invention removes the air bubbles from the adhesives, thus dispensing more accurate adhesive amounts.

### DESCRIPTION OF DRAWINGS

FIG. 1 is a block diagram showing a configuration of a centrifugal separation device for removing air bubbles from materials filled in syringes according to the present invention.

FIG. 2 is an enlarged perspective view showing a rotary body and a stand in FIG. 1.

FIGS. 3A to 3C are sectional views showing the operating states of the rotary body and the stand in FIG. 1.

### BEST MODE FOR INVENTION

Hereinafter, an explanation on a centrifugal separation device for removing air bubbles from materials filled in syringes according to the present invention will be in detail given with reference to the attached drawings.

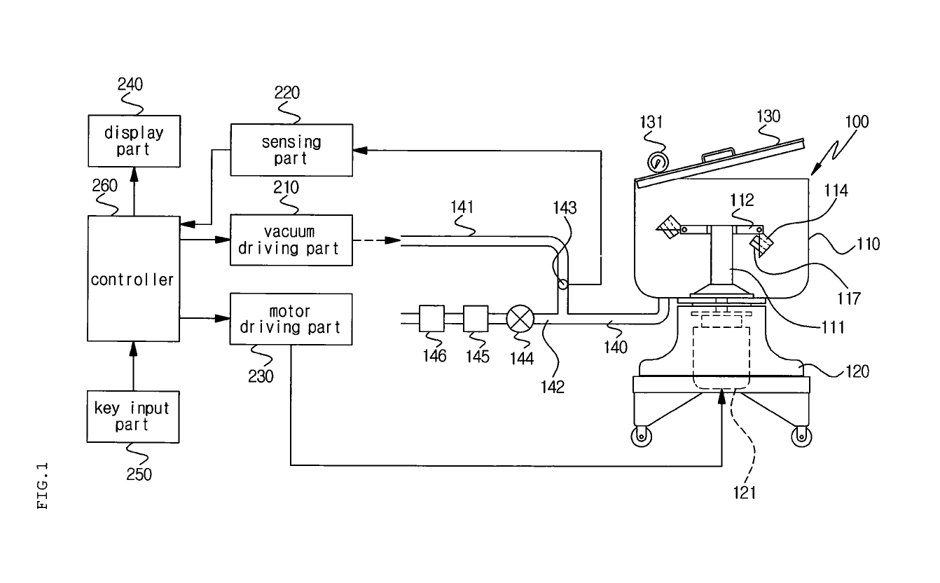

FIG. 1 is a block diagram showing a configuration of a centrifugal separation device for removing air bubbles from materials filled in syringes according to the present invention.

As shown, a centrifugal separation device for removing air bubbles from materials filled in syringes according to the present invention largely includes a centrifugal separator 100, a vacuum driving part 210, a sensing part 200, a motor driving part 230, a display part 240, a key input part 250, and a controller 260.

The centrifugal separator 100 includes a round body 110, a supporter 120 supporting the body 110, and a sealing cover 130 sealably mounted on top of the body 110.

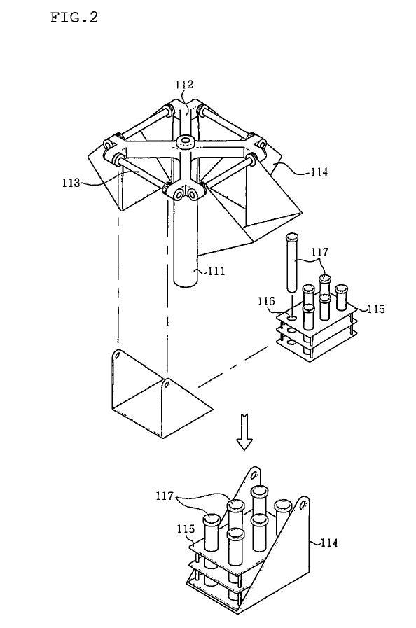

As shown in FIG. 2, the body 110 includes a rotary shaft 111 rotated by the operation of a motor 121, a rotary body 112 connected to the top end periphery of the rotary shaft 111, hinge shafts 113 formed on the four faces of the rotary body 112, and mounting members 114 coupled to the hinge shafts 113, at the inside thereof.

A stand 115 on which a plurality of holes 116 is formed is mounted into each mounting member 114, and a syringe 117 into which an adhesive is filled is insertedly fitted into the holes 116.

In this case, the syringe 117 desirably has a volume of 10 cc or 30 cc, but of course, the syringe 117 may have a larger volume than the 10 cc or 30 cc syringe, without any limitation.

Further, a connection pipe 140 is located on the underside of the body 110 in such a manner as to be branched into a vacuum pipe 141 and a vacuum releasing pipe 142.

The vacuum pipe 141 has a vacuum sensor 143 mounted at the inside thereof so as to sense a vacuum pressure.

An opening/closing valve 144, an air filter 145, and a silencer 146 are mounted on the vacuum releasing pipe 142, and a pressure gauge 131 is attached to the sealing cover 130.

Further, the vacuum driving part 210 absorbs the air from the interior of the body 110 through the vacuum pipe 141 to reduce the internal pressure of the body 110 to a given pressure.

According to the present invention, it is desirable that the internal pressure of the body 110 be kept in the range from 50 torr to 60 torr while the centrifugal separator 100 is being operated.

Also, the sensing part 220 performs a signal process for the pressure value detected from the vacuum sensor 143 to input the processed signal to the controller 260.

The motor driving part 230 drives the motor 121 to rotate the rotary shaft 111 located inside the body 110.

According to the present invention, it is desirable that the motor 121 be driven in the range from 700 RPM to 1200 RPM for 3 to 7 minutes while the centrifugal separator 100 is being operated.

The display part 240 displays the current internal pressure of the body 110 and the rotational speed RPM of the syringes 117.

The key input part 250 has a plurality of functional switches setting the internal pressure of the body 110, the rotational speed of the motor 121, the driving time of the motor 121, and the like.

The controller 260 operates and controls the centrifugal separator 100, and to do this, the controller 260 constantly maintains the internal pressure of the body 110 to the set value by the key input part 250 and drives the motor 121 at the set RPM and for the set driving time.

Hereinafter, an explanation on the operation of the centrifugal separation device according to the present invention will be given.

First, the sealing cover 130 of the body 110 of the centrifugal separator 100 is open by a user, and the syringes 117 into which adhesives are filled are insertedly fitted to the holes 116 of the stands 115. After that, the stands 115 are fixedly mounted into the mounting members 114 of the rotary body 112.

Next, the sealing cover 130 is closed, and the opening/closing valve 144 of the vacuum releasing pipe 142 is closed.

If the syringes 117 into which adhesives are filled are mounted into the centrifugal separator 100, like this, the internal pressure of the body 110 of the centrifugal separator 100 and the rotational speed RPM of the motor 121, and the driving time of the motor 121 are set through the key input part 250.

For example, the internal pressure of the body 110 is set to 60 torr, the RPM of the motor 121 to 900, and the driving time of the motor 121 to 5 minutes.

If the key input is transmitted to the controller 260, the controller 260 drives the vacuum driving part 210 to lower the internal pressure of the body 110.

The vacuum driving part 210 absorbs the air from the interior of the body 110 through the vacuum pipe 141 to reduce the internal pressure of the body 110, and at this time, the vacuum driving part 210 detects the pressure inputted from the vacuum sensor 143 and the sensing part 220 and maintains the internal pressure of the body 110 to the set value, that is, 60 torr.

If the internal pressure of the body 110 reaches the set value, the controller 260 controls the motor driving part 230 to drive the motor 121.

In this case, the motor driving part 230 drives the motor 121 to maintain the motor 121 to the set RPM under the control of the controller 260.

If the motor 121 rotates, accordingly, the rotary shaft 111 rotates, thus rotating the rotary body 112.

The rotation of the rotary body 112 allows the mounting members 114 coupled to the hinge shafts 113 formed on the four faces of the rotary body 112 to be rotated and also moved up and down.

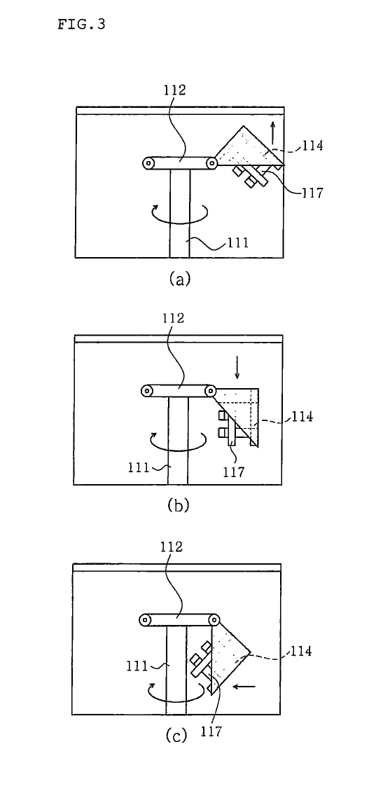

That is, as shown in FIGS. 3A to 3C, as the rotary body 112 rotates, the mounting members 114 are moved up and down around the hinge shafts 113 through the centrifugal force and rotary motion of the rotary body 112, in the sequential order as shown.

Accordingly, the rotational centrifugal force is strongly applied to the adhesives filled in the syringes 117, which allows the fine air bubbles existing in the adhesives to be removed. In this case, one of the important features of the present invention is a pressure.

That is, since the internal pressure of the body 110 is lower than the air pressure through the centrifugal separation, the fine air bubbles existing in the adhesives can be easily removed.

As a result, even the micro-fine air bubbles existing in the adhesives filled in the syringes 117 can be removed from the adhesives by means of the internal pressure of the body 110 and the physical phenomenon according to the centrifugal separation.

If the motor 121 is driven for the set time, that is, 5 minutes, the controller 260 stops the outputting to the motor driving part 230 to stop driving the motor 121 and also stops the outputting to the vacuum driving part 210.

Accordingly, the rotary shaft 111 and the rotary body 112 stop.

Next, the opening/closing valve 144 of the vacuum releasing pipe 142 is open by the user to return the internal pressure of the body 110 to a normal temperature, and if the above-mentioned processes are finished, the sealing cover 130 is open to draw the syringes 117, thus completing the process of removing the air bubbles from the adhesives.

According to the present invention, further, the syringes 117 from which the air bubbles are removed through the vacuum centrifugal separation are kept cold (at −40° C. or less), and when used later, the above-mentioned vacuum centrifugal separation is conducted to remove the air bubbles generated again from the adhesives filled in the syringes 117.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A centrifugal separation device for removing air bubbles from materials filled into syringes, the device comprising:
a centrifugal separator having a round body, a sealing cover sealably mounted on top of the body, a rotary shaft and a rotary body rotated by the operation of a motor, mounting members coupled to hinge shafts formed on the four faces of the rotary body, the syringes mounted on the mounting members through respective stands, a vacuum pipe and a vacuum releasing pipe connected on the underside of the body, and a vacuum sensor mounted at the inside of the vacuum pipe;
a vacuum driving part adapted to absorb the air from the interior of the body through the vacuum pipe to reduce the internal pressure of the body to a given pressure;
a sensing part adapted to input the pressure value detected from the vacuum sensor to a controller;
a motor driving part adapted to drive the motor to rotate the rotary shaft; and
the controller adapted to operate the centrifugal separator, to constantly maintain the internal pressure of the body to a set value, and to drive the motor at set RPM and for set driving time.

2. The centrifugal separation device according to claim 1, wherein the internal pressure of the body is in the range from 50 torr to 60 torr while the centrifugal separator is being operated.

3. The centrifugal separation device according to claim 1, wherein the motor is driven in the range from 700 RPM to 1200 RPM while the centrifugal separator is being operated.
